(19) United States
(12) Patent Application Publication
(10) Pub. No.: US 2026/0162457 A1
(43) Pub. Date: Jun. 11, 2026

(54) USER INTERFACE GUIDES FOR BIOMETRIC ENROLLMENT AND/OR CAPTURE

(71) Applicant: Secure Identity, LLC, New York, NY (US)

(72) Inventors: Vladimir Stojkovski, New York, NY (US); Jeff Valeo, New York, NY (US); Connie Ko, New York, NY (US); Austin Puckett, New York, NY (US); Raymond Protasiewicz, New York, NY (US)

(21) Appl. No.: 19/379,753

(22) Filed: Nov. 5, 2025

Related U.S. Application Data
(60) Provisional application No. 63/716,706, filed on Nov. 5, 2024.

(51) Int. Cl. G06V 40/16; H04N 23/63

(52) U.S. Cl. CPC G06V 40/166; H04N 23/634

(57) ABSTRACT

In various implementations, a system captures one or more images of a person, detects a face in the one or more images, applies a reticle to a portion corresponding to the face wherein a first relationship between an edge of the reticle and the face is proportional to second relationship between the person and a capture volume, displays the one or images with the reticle, and adjusts the display for movement. In some implementations, a system captures one or more images of a person, detects a face, applies current alignment marks and goal alignment marks around a portion of the one or more images corresponding to the face based at least on pitch/roll/yaw of the face, displays the one or images with the current alignment marks and the goal alignment marks, and adjusts the display for movement.

### CROSS-REFERENCE TO RELATED APPLICATION(S)

This application is a nonprovisional patent application of and claims the benefit of U.S. Provisional Ser. No. 63/716,706 , filed Nov. 5, 2024 and titled “User Interface Guides for Biometric Enrollment and/or Capture,” the disclosure of which is hereby incorporated herein by reference in its entirety.

### FIELD

The described embodiments relate generally to biometric enrollment and/or capture.

More particularly, the present embodiments relate to user interface guides for biometric enrollment and/or capture.

### BACKGROUND

Biometric identification systems may identify people using biometrics. Biometrics may include fingerprints, palm prints, irises, eyes, faces, voices, gaits, pictures, or other identifying characteristics about a person. A biometric identification system may capture information about a biometric using a biometric reader and identify a person by comparing the captured information against stored information. For example, an image sensor may capture an image of a fingerprint and compare the image of the fingerprint against stored fingerprint images.

### SUMMARY

The present disclosure relates to user interface guides for biometric enrollment and/or capture. In various implementations, a system captures one or more images of a person, detects a face in the one or more images, applies a reticle to a portion of the one or more images corresponding to the face wherein a first relationship between an edge of the reticle and the face is proportional to second relationship between the person and a capture volume, displays the one or images with the reticle, and adjusts the display of the one or more images with the reticle for movement. In some implementations, a system captures one or more images of a person, detects a face in the one or more images, applies current alignment marks and goal alignment marks around a portion the of one or more images corresponding to the face based at least on pitch/roll/yaw of the face, displays the one or images with the current alignment marks and the goal alignment marks, and adjusts the display of the one or more images with the current alignment marks and the goal alignment marks for movement.

### BRIEF DESCRIPTION OF THE DRAWINGS

The disclosure will be readily understood by the following detailed description in conjunction with the accompanying drawings, wherein like reference numerals designate like structural elements.

FIG. 1A depicts a first view of an example biometric device and an associated capture volume.

FIG. 1B depicts a second view of the example biometric device and the associated capture volume.

FIG. 2A depicts a first example user interface.

FIG. 2B depicts the first example user interface after movement.

FIG. 2C depicts the first example user interface after the person reaches the capture volume.

FIG. 2D depicts the first example user interface with active text banner feedback.

FIG. 3A is a first example image depicting example pitch/roll/yaw of a person's head around axes defined by the person's head.

FIG. 3B is a second example image depicting example pitch/roll/yaw of a person's head around axes defined by the person's head.

FIG. 4A depicts a second example user interface.

FIG. 4B depicts the second example user interface after movement.

FIG. 5A depicts a third example user interface.

FIG. 5B depicts the third example user interface after movement.

FIG. 6 is a flow chart illustrating a first example method for providing user interface guides for biometric enrollment and/or capture. The method may be performed by devices of FIGS. 1A-1B and/or 8 and may provide user interfaces, such as the user interfaces of FIGS. 2A-2B.

FIG. 7 is a flow chart illustrating a second example method for providing user interface guides for biometric enrollment and/or capture. The method may be performed by devices of FIGS. 1A-1B and/or 8 and may provide user interfaces, such as the user interfaces of FIGS. 4A-5B.

FIG. 8 depicts an example system for providing user interface guides for biometric enrollment and/or capture.

FIG. 9A depicts a fourth example user interface.

FIG. 9B depicts the fourth example user interface after movement.

FIG. 10A depicts a fifth example user interface.

FIG. 10B depicts the fifth example user interface after movement.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, apparatuses, methods, and computer program products that embody various elements of the present disclosure. However, it should be understood that the described disclosure may be practiced in a variety of forms in addition to those described herein.

One challenge that may exist in capturing biometrics from people and/or enrolling people in biometric systems is how to provide guidance to people attempting to capture biometrics and/or enroll in biometric systems. People may need to position themselves in particular ways with respect to one or more biometric reader devices and/or other devices while one or more biometrics are being captured and/or while the people are being enrolled in one or more biometric systems. Such biometric capture and/or enrollment may have increasing problems (such as inaccuracy, need for additional hardware and/or software resources to perform the biometric capture and/or enrollment, and so on) the further off the people are from where they need to position themselves. Visual, audio, and/or other guidance may be provided to guide the people from their current position to (and//or at least closer to) the particular position. However, such guidance may not be comprehensible to the people and/or may take the people a great deal of time and effort to understand and follow as part of biometric capture and/or enrollment. If the people are not able to follow the guidance, the guidance and/or additional guidance may need to be provided until the people position themselves correctly. This may require a great deal of interaction with one or more devices providing the guidance, which may cause such devices to expend unnecessary hardware and/or software resources as part of such interaction and may result in less accurate biometric capture and/or enrollment if the people are unable to follow such guidance.

For example, a biometric device may capture one or more facial images of people and/or a portion thereof using one or more camera and/or other image sensors. The biometric device may have a capture volume, or a designated area with respect to the biometric device where the biometric device will attempt to capture the one or more facial images of the people using the using one or more camera and/or other image sensors. The capture volume may not be where people would naturally stand during biometric capture, such as where they would naturally stand closer. If the person is outside the capture volume, inaccuracies may be caused. As such, the biometric device may omit capturing facial images when people are outside the volume, avoid using any images captured outside of the capture volume, and so on. By way of illustration, perspective distortion may be caused when people are closer to the biometric device than the capture volume. Such perspective distortion may warp images of the people's faces and may make it more challenging for the biometric device to accurately measure the people. By way of another illustration, people being further from the biometric device than the capture volume may prevent operations, such as liveness detection where it may be determined whether or not facial images are captured from actual people as opposed to two-dimensional images held up in front of the one or more camera and/or other image sensors. Such operations may involve use of one or more proximity and/or other sensors (such as depth sensors, distance sensors, and so on), such as by detecting distances to people, and such sensors may not be as accurate when the distance to the people increases beyond certain limits (such as where the people are far enough from the biometric device that they are outside the capture volume. People being outside the capture volume may also cause privacy issues, such as where other people near the biometric device can view captured faces and/or otherwise interfere with the operation of the biometric device because people using the biometric device are outside the capture volume and thus are not blocking information displayed. Such a biometric device may provide guidance to people so assist the people in moving to position themselves within capture volume instead of too close, too far, and/or otherwise outside the capture volume.

By way of another example, the biometric device may capture one or more facial images of people and/or a portion thereof using one or more camera and/or other image sensors as part of biometric enrollment. Facial images captured for biometric enrollment may have different requirements than facial images captured for other purposes, such as biometric identification (where an identity of an person may be determined by comparing a biometric captured from the person to biometric data stored for multiple people and associated with identities of those multiple people), biometric verification (where an identity of a person asserting to be a particular person is verified by comparing a currently obtained biometric to stored biometric data for the particular person), and so on. By way of illustration, biometric identification, verification, and/or other processes may be more accurate and/or faster when biometric data obtained during biometric enrollment satisfies certain requirements, such as where the pitch/roll/yaw of people's heads is as close to zero and/or otherwise minimized with respect to the one or more cameras and/or other image sensors used to capture images of people's faces during biometric enrollment. In order to accomplish this, guidance during biometric enrollment may be provide to people to assist the people in positioning themselves with respect to the biometric device to reduce to zero and/or otherwise minimized the pitch/roll/yaw of the people's heads with respect to the one or more cameras and/or other image sensors during biometric enrollment.

Facial recognition enrollment, identification, and/or verification systems may be optimized by controlling and meeting relevant capture quality thresholds. Distance may be an important parameter that may contribute to facial recognition capture quality. Facial biometric capture systems may estimate a person's distance based on a camera's known resolution and active detection of the number of pixels between the person's eyes (inter-eye pixel width). This feature may allow distance parameters to be configured to a minimum and maximum capture distance to create a capture volume. However, the ideal capture volume for biometric capture may not always align with a comfortable distance for a person approaching a biometric device (such as a station, kiosk, and so on).

A person approaching too close to the camera may introduce perspective and/or lens distortion to the image, which may be detrimental for biometric systems. People may naturally tend to approach a biometric device including a touch screen at a comfortable distance for screen interaction. However, this may be too close for an optimized biometric capture. Based on this, it may be advantageous to dissuade a person from approaching closer than a defined distance.

Conversely, a person being too far from the camera may introduce additional challenges. The further a person is from the camera, the lower resolution the person's face region may be in the image. Face biometric systems may require a face to be captured within a specified resolution threshold, such as determined through inter-eye pixel width. While further distances may be mitigated with higher resolution cameras, facial recognition camera systems may utilize additional sensors for liveness detection and low light capture. This may include infrared image sensors and illuminators for low light capture and infra-red dot projectors for depth detection. Due to the physics and limitations of these sensors, there may be a maximum effective range. Another reason capture distance may be limited is to minimize the capture volume to enhance privacy, to prevent capturing the wrong subject, and so on.

For these reasons, a user interface may be configured that influences people to stand within a specific distance range that may otherwise not be an intuitive approach distance. Examples of such a specified distance range, which may define part of a capture volume, may include 0.7 meters to 1 meter, 0.5 meters to 1.1 meters, and so on.

In various implementations, a biometric device display interface may influence a person to approach a biometric device at an optimal distance for biometric capture. This may be accomplished by displaying a live camera feed combined with dynamic face tracking visual indicators that communicate when the person is too close, too far, or within the preferred capture range.

In some implementations, an intuitive interface for a biometric device may guide people to stand within a pre-configured capture volume. The interface may utilize a live camera feed, projected onto a display, in conjunction with a dynamic face tracking reticle (such as an oval) and feedback indicators.

The display may be configured to be a portrait orientation with a mirrored video feed. This may ensure people of various heights are able to see themselves clearly on the display in real time. The camera field of view may similarly be portrait oriented to capture the full height range of people. The portrait-oriented display and field of view of the camera may provide an interface very similar to a mirror, a familiar and intuitive mental model.

Overlaid on this mirror-like interface may be a face tracking reticle (such as an oval) that may follow the most dominant face within the camera capture zone. Face dominance may be determined by the closest face that is positioned with a specified head pose threshold. This may communicate to the person and any attendant of the biometric device the face that the system is targeting. During capture the reticle may be designed to remain a static predetermined size, so that as people approach their face increasingly fills the shape. The reticle size may be calibrated so that when a person with an average size face approaches a minimum capture distance threshold, their face fully fills the reticle. If the person approaches closer than this distance the reticle perimeter may begin to noticeably obstruct their face, encouraging the person to move backward within the capture range. If a person were to be positioned too far away, the person's face may appear small within the reticle, encouraging the person to continue to approach the camera. This interface may draw parallels from existing mental models of face cutout photo boards used at events, carnivals and theme parks.

To further influence person's approach distance, the system may utilize color change (or another state change) of the face tracking reticle to communicate as the person approaches or leaves the intended capture volume. As the person approaches a defined distance (or distance range and so on) the reticle outline may progressively change color, pattern, shape, style, or the like, reaching an altered state when the person reaches the defined distance or distance range. Similarly, if the person approaches too close the reticle may begin to change to its prior state (or another state) as the person continues to move toward the camera. Similarly, if a person were to approach the biometric device from the side and step into frame too close, the reticle may be in a state indicating the person is not in the capture zone and change to a second state, signifying the person is in the capture zone, as the person moves into the defined capture zone.

In addition to the color or other state change, the system may utilize active text banner feedback to provide instructions to move closer or further, in conjunction with the aforementioned interface elements. These text banners may track closely to the face tracking reticle as opposed to a static location on screen. This may make the banners more noticeable as people may tend to focus on their own faces. The text may generally track to the top of the face tracking reticle, based on testing what people may experience as more noticeable. However, when a person is very tall or approaches the camera very close, if the text banner cannot fit within the frame above their head, it automatically may move to below the head so it may still be read.

One or more of these elements may combine to provide an intuitive user interface that may apply to facial biometric enrollment, identification, and/or verification. Not only may these elements communicate information (such as whether the person is in the capture zone, his or her head is positioned correctly, and so on) to the person, but in some implementations they may also communicate such information to an attendant. For example, this interface may enable an attendant to provide more precise distance instruction. Additionally, the interface may enable the attendant to quickly comprehend which person the system is targeting to avoid capturing the wrong subject. For example, if a bystander or child is close by, the interface may enable the attendant to intervene and instruct the person to better position for capture.

This interface may be applied to a variety of different biometric devices, such as biometric identification stations, mobile app face verifications, and so on.

The above may provide improved user interfaces as well as enabling performance of functions that were previously not performable and enabling more efficient operation while expending less work, eliminating unnecessary hardware and/or other components, and more efficiently using hardware, software, network, and/or other resources. This may improve the operation of systems involved by reducing unnecessary components, increasing the speed at which the systems perform operations, and/or reducing consumption of hardware, software, network, and/or other resources.

The present disclosure relates to user interface guides for biometric enrollment and/or capture. In various implementations, a system captures one or more images of a person, detects a face in the one or more images, applies a reticle to a portion of the at one or more images corresponding to the face wherein a first relationship between an edge of the reticle and the face is proportional to second relationship between the person and a capture volume, displays the one or images with the reticle, and adjusts the display of the one or more images with the reticle for movement. In some implementations, a system captures one or more images of a person, detects a face in the one or more images, applies current alignment marks and goal alignment marks around a portion of the one or more images corresponding to the face based at least on pitch/roll/yaw of the face, displays the one or images with the current alignment marks and the goal alignment marks, and adjusts the display of the one or more images with the current alignment marks and the goal alignment marks for movement.

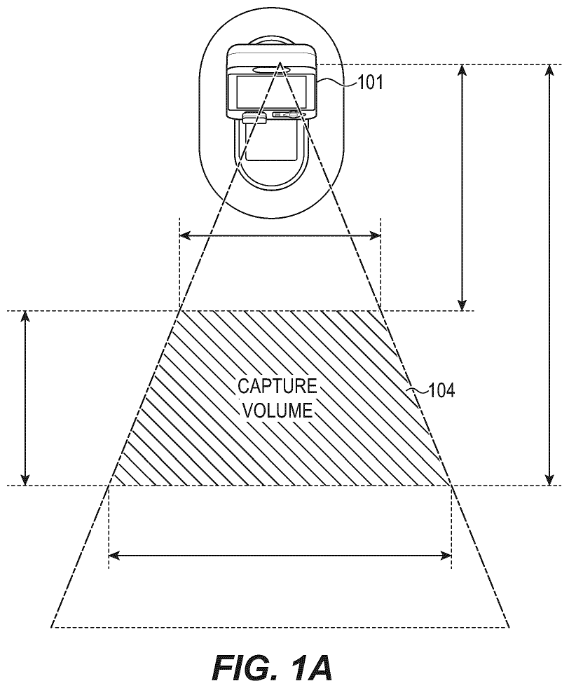

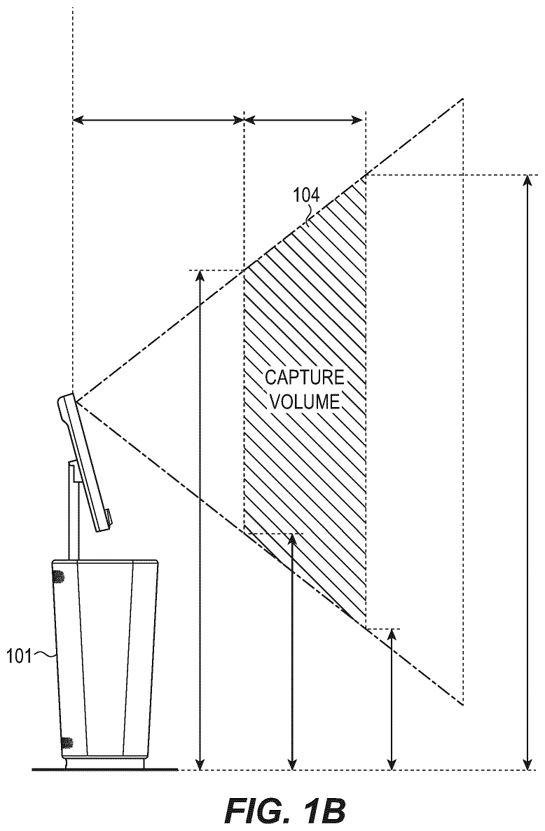

These and other embodiments are discussed below with reference to FIGS. 1-8. However, those skilled in the art will readily appreciate that the detailed description given herein with respect to these Figures is for explanatory purposes only and should not be construed as limiting.

FIG. 1A depicts a first view of an example biometric device 101 and an associated capture volume 104. FIG. 1B depicts a second view of the example biometric device 101 and the associated capture volume 104.

As described above, the biometric device 101 may capture one or more facial images of people and/or a portion thereof using one or more camera and/or other image sensors. The biometric device 101 may have a capture volume 104, or a designated area with respect to the biometric device 101 where the biometric device 104 will attempt to capture the one or more facial images of the people using the using one or more camera and/or other image sensors. The capture volume 104 may not be where people would naturally stand during biometric capture, such as where they would naturally stand closer. If the person is outside the capture volume, inaccuracies may be caused. As such, the biometric device 101 may omit capturing facial images when people are outside the volume, avoid using any images captured outside of the capture volume, and so on.

By way of illustration, perspective distortion may be caused when people are closer to the biometric device 101 than the capture volume 104. Such perspective distortion may warp images of the people's faces and may make it more challenging for the biometric device 101 to accurately measure the people.

By way of another illustration, people being further from the biometric device than the capture volume 104 may prevent operations, such as liveness detection where it may be determined whether or not facial images are captured from actual people as opposed to two-dimensional images held up in front of the one or more camera and/or other image sensors. Such operations may involve use of one or more proximity and/or other sensors (such as depth sensors, distance sensors, and so on), such as by detecting distances to people, and such sensors may not be as accurate when the distance to the people increases beyond certain limits (such as where the people are far enough from the biometric device that they are outside the capture volume 104. People being outside the capture volume 104 may also cause privacy issues, such as where other people near the biometric device can view captured faces and/or otherwise interfere with the operation of the biometric device 101 because people using the biometric device are outside the capture volume 104 and thus are not blocking information displayed. Such a biometric device 101 may provide guidance to people so assist the people in moving to position themselves within capture volume 104 instead of too close, too far, and/or otherwise outside the capture volume.

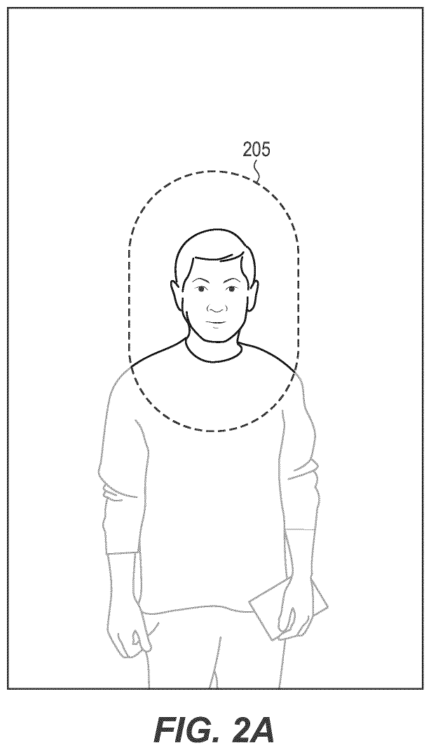

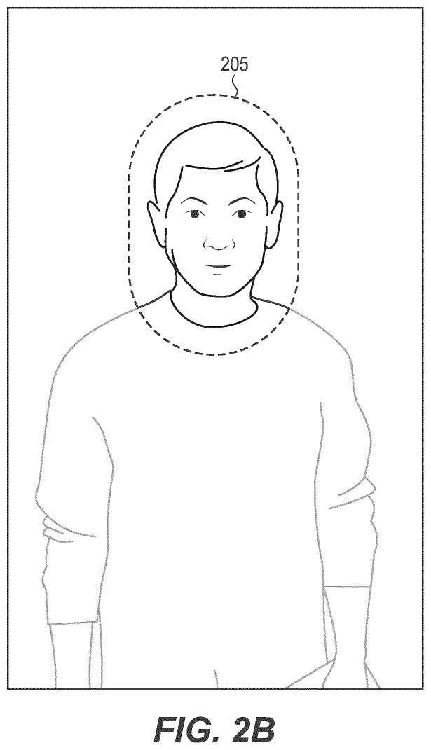

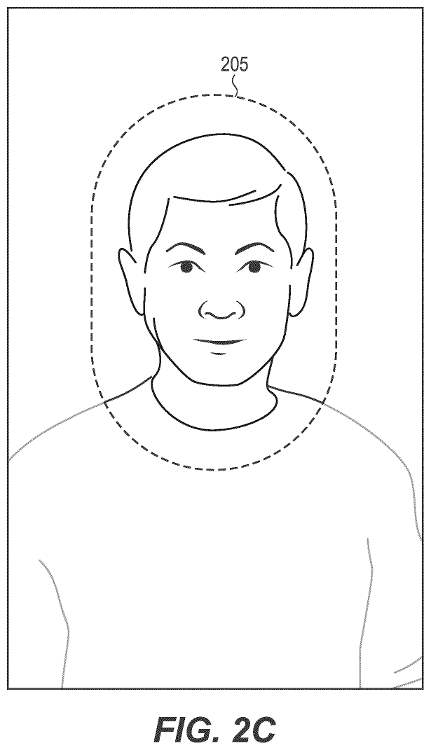

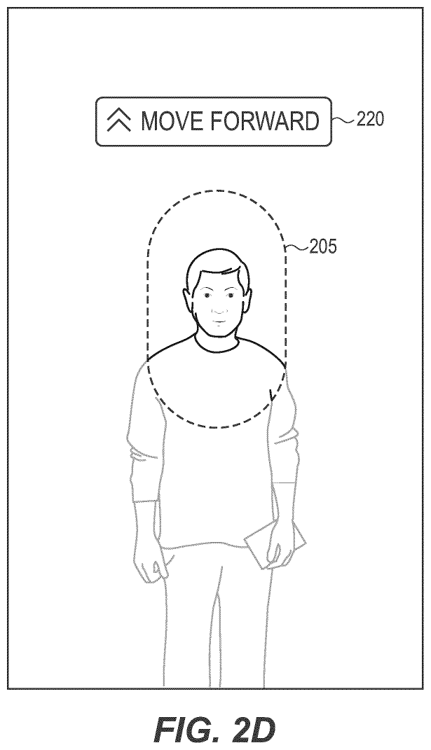

FIG. 2A depicts a first example user interface. The first example user interface may be used to provide the guidance to people discussed above so assist the people in moving to position themselves within capture volume instead of too close, too far, and/or otherwise outside a capture volume, such as the capture volume 104 of FIGS. 1A-1B.

The user interface may include a reticle 105 (or silhouette). The reticle 105 may be applied to one or more images of a person, such as video captured of the person that is then displayed with the reticle to provide guidance to the person. The reticle 105 may be applied such that the reticle is applied with respect to the person's face in the one or more images of the person and a capture volume, such as the capture volume 104 of FIGS. 1A and 1B.

For example, reticle 105 may be applied at the height of the person's face in the one or more images. This may enable providing of guidance with respect to the persons'face regardless of the person's particular height, whether the person is sitting or standing, whether or not the person is using a mobility assistance device, and so on. As the reticle 105 may be applied based at least one the position of the person's face in the one or more images, the person may not have to move to align their face with the reticle 105.

The relationship between the edges of the reticle 105 and the person's face may correspond to the person's relationship to a capture volume, such as the capture volume 104 of FIGS. 1A and 1B. For example, the closer a person becomes to the capture volume, the smaller the distance may become between the edges of the reticle 105 and the person's face. Conversely, the further a person goes from the capture volume, the greater the distance may become between the edges of the reticle 105 and the person's face. Similarly, the edges of the reticle 105 may go beyond the person's face when the person exceeds the capture volume and the amount that the edges of the reticle go beyond the person's face may be proportional to the amount that the person has exceeded the capture volume. In this way, the person may see from the relationship between the reticle 105 and their face whether to move forward or back, as well as how much. Once the person is within the capture volume, a digital representation of a biometric (such as a facial image, a retina image, an iris image, and so on) may be captured.

As shown in FIG. 2A, there is space between the reticle 105 and the person's face within the reticle 105, indicating that the person should move forward to approach the capture volume. FIG. 2B depicts the first example user interface after movement. As shown, the space between the reticle 105 and the person's face within the reticle 105 has decreased, indicating that the person has moved forward to approach the capture volume. FIG. 2C depicts the first example user interface after the person reaches the capture volume.

In some implementations, a display associated with the user interface may be configured to be a portrait orientation with a mirrored video and/or image feed. This may ensure people of various heights are able to see themselves clearly on the display in real time. An associated camera or other image sensor field of view may similarly be portrait oriented to capture the full height range of people. The portrait-oriented display and field of view of the camera or other image sensor may provide an interface very similar to a mirror, a familiar and intuitive mental model.

The reticle 105 may follow the most dominant face within a camera or other image sensor capture zone. Face dominance may be determined by the closest face that is positioned with a specified head pose threshold. This may communicate to the person and any attendant of an associated biometric device the face that the system is targeting. During capture the reticle 105 may be designed to remain a static predetermined size, so that as people approach their face increasingly fills the shape. The reticle 105 size may be calibrated so that when a person with an average size face approaches a minimum capture distance threshold, their face may fully fill the reticle 105. If the person approaches closer than this distance the reticle 105 perimeter may begin to noticeably obstruct their face, encouraging the person to move backward within the capture range. If a person were to be positioned too far away, the person's face may appear small within the reticle 105, encouraging the person to continue to approach. This interface may draw parallels from existing mental models of face cutout photo boards used at events, carnivals and theme parks.

To further influence person's approach distance, the user interface may use other indicator elements to communicate as the person approaches or leaves the intended capture volume. For example, the user interface may utilize color change of the reticle 105 (or another state change) between a first color (white) and a second color (green) to communicate as the person approaches or leaves the intended capture volume. In one example, as the person approaches a defined distance (or distance range and so on) the reticle 105 outline may progressively or systematically change state (as shown in FIG. 2C) from white to green, reaching full green color when the person reaches the defined distance or distance range. Similarly in this example, if the person approaches too close the reticle 105 may begin to fade to white as the person continues to move toward the camera. Similarly in this example, if a person were to approach from the side and step into frame too close, the reticle 105 may be white and fade to green as the person moves back toward the defined capture zone.

In addition to the state change, the system may utilize active text banner feedback to provide instructions to move closer or further, in conjunction with the aforementioned interface elements. These text banners may track closely to the reticle 105 as opposed to a static location on screen. This may make the banners more noticeable as people may tend to focus on their own faces. The text may generally track to the top of the reticle 105, based on testing what people may experience as more noticeable. However, when a person is very tall or approaches the camera very close, if the text banner cannot fit within the frame above their head, it automatically may move to below the head so it may still be read. An example of active text banner feedback 120 is shown in FIG. 2D.

The user interface may also modify the area outside the reticle 105 and/or within the reticle 105 in order to draw the person's attention to the area within the reticle 105. For example, as shown, the area around the reticle 105 may be blurred while the area within the reticle is not blurred. However, it is understood that this is an example and that other modifications may be performed in order to order to draw the person's attention to the area within the reticle 105 and/or for other purposes without departing from the scope of the present disclosure.

Further, the reticle 105 is shown as an oval or a pill. However, it is understood that this is an example. In various implementations, other shapes, marks, and/or other indicators may be used without departing from the scope of the present disclosure.

The above describes applying the reticle 105 based at least on a relationship between a person and a capture volume as well as a position of the person's face in one or more images. Such positions may be determined by analyzing the one or more images, using one or more sensors, such as proximity sensors, depth sensors, distance sensors, and so on, or the like. Various configurations are possible and contemplated without departing from the scope of the present disclosure.

The above may be used to guide people to various portions of the capture volume. For example, the above may direct the person to a middle of the capture volume 104 instead of one of the edges to lower the possibility that ordinary movement of the person may take him or her outside of the capture volume during biometric capture. Various configurations are possible and contemplated without departing from the scope of the present disclosure.

As also discussed above, a biometric device (like the biometric device 101 of FIGS. 1A-1B and/or another biometric device) may capture one or more facial images of people and/or a portion thereof using one or more camera and/or other image sensors as part of biometric enrollment. Facial images captured for biometric enrollment may have different requirements than facial images captured for other purposes, such as biometric identification (where an identity of an person may be determined by comparing a biometric captured from the person to biometric data stored for multiple people and associated with identities of those multiple people), biometric verification (where an identity of a person asserting to be a particular person is verified by comparing a currently obtained biometric to stored biometric data for the particular person), and so on. By way of illustration, biometric identification, verification, and/or other processes may be more accurate and/or faster when biometric data obtained during biometric enrollment satisfies certain requirements, such as where the pitch/roll/yaw of people's heads is as close to zero and/or otherwise minimized with respect to the one or more cameras and/or other image sensors used to capture images of people's faces during biometric enrollment. In order to accomplish this, guidance during biometric enrollment may be provide to people to assist the people in positioning themselves with respect to the biometric device to reduce to zero and/or otherwise minimized the pitch/roll/yaw of the people's heads with respect to the one or more cameras and/or other image sensors during biometric enrollment.

Pitch/roll/yaw requirements may be set for a system. Pitch/roll/yaw may be estimated or calculated using facial features and compared to the requirements. Capture of facial images and/or other biometrics may be performable when the pitch/roll/yaw is within one or more thresholds of the pitch/roll/yaw requirements. Pitch/roll/yaw requirements may be set with a lower threshold or thresholds for biometric enrollment (such as 10 or 5 degrees pitch/roll/yaw) for each than verification and/or identification (such as 15 degrees pitch/roll/yaw) (as compared with resolution requirements, which may be higher for biometric enrollment than verification and/or identification). This may be due to the fact that large pitch/roll/yaw for an enrollment image may result in a portion of the person's face not being captured during biometric enrollment that can then not be compared against using images obtained for biometric verification and/or identification. Due to this, pitch/roll/yaw requirements set with a lower threshold or thresholds for biometric enrollment for each than verification and/or identification may result in more accurate subsequent biometric verification and/or identification.

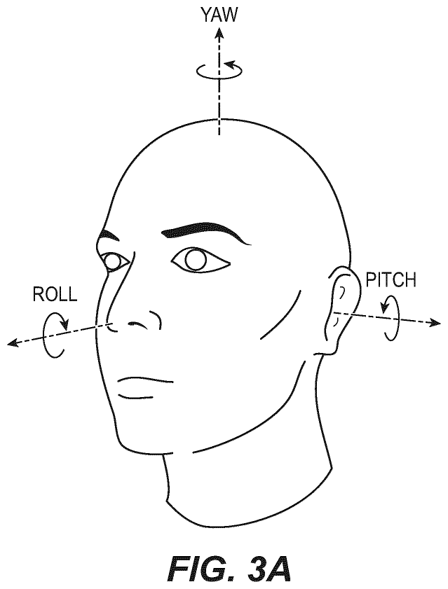

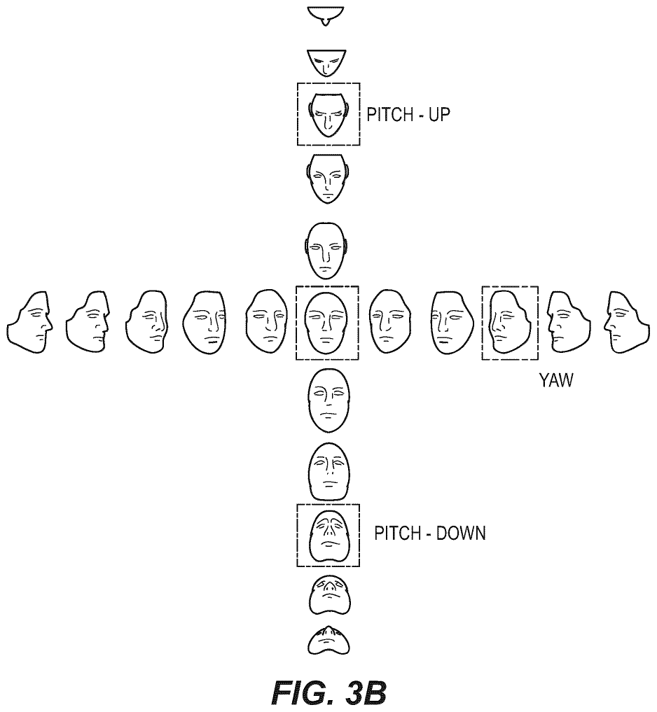

FIG. 3A is a first example image depicting example pitch/roll/yaw of a person's head around axes defined by the person's head. FIG. 3B is a second example image depicting example pitch/roll/yaw of a person's head around axes defined by the person's head. Rotation around a front-to-back axis is roll. Rotation around a side-to-side axis is pitch. Rotation around a vertical axis is yaw.

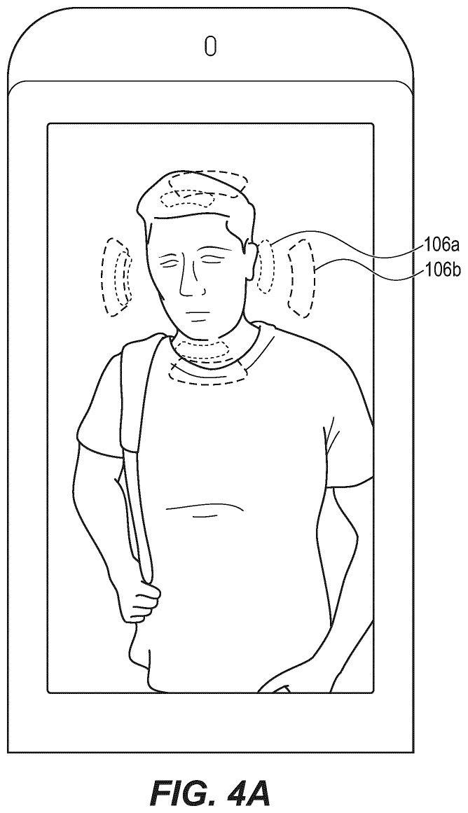

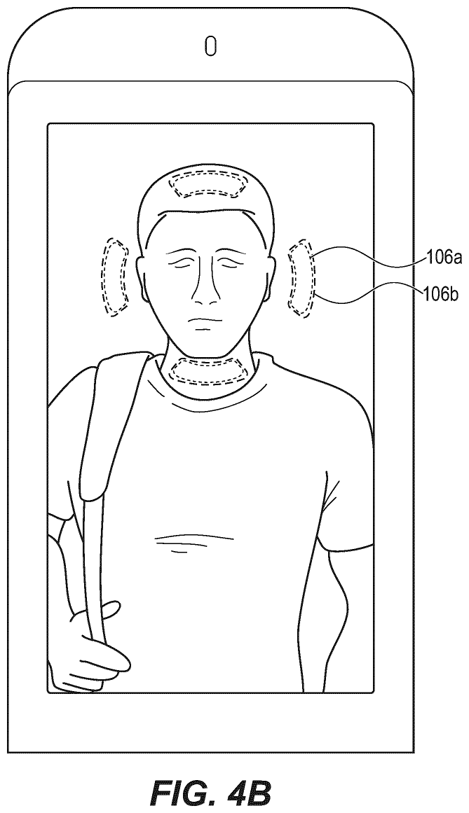

FIG. 4A depicts a second example user interface. The user interface may include current alignment marks 106A and goal alignment marks 106B positioned around a person's head. The current alignment marks 106A and/or the goal alignment marks 106B may be multi-axis positioning and distance alignment cue marks. The position of the current alignment marks 106A with respect to the goal alignment marks 106B may indicate the amount of roll/pitch/yaw.

For example, the closer the current alignment marks 106A are to the goal alignment marks 106B, the smaller the amount of roll/pitch/yaw may be. Conversely, the further the current alignment marks 106A are from the goal alignment marks 106B, the greater the amount of roll/pitch/yaw may be. Thus, a person can move their head so that the current alignment marks 106A move closer to the goal alignment marks 106B in order to reduce pitch/roll/yaw, such as to zero. FIG. 4B depicts the second example user interface after movement that reduces pitch/roll/yaw. Once the person has reduced reduce pitch/roll/yaw, such as to zero, a digital representation of a biometric (such as a facial image, a retina image, an iris image, and so on) may be captured. The digital representation of the biometric may be used to enroll the person in a biometric system. Use of this user interface may speed up enrollment.

The current alignment marks may overlap, overlie, be contained within, or contain the goal alignment marks when the person's head is in the proper position for digital capture of the biometric. As another option, a single set of alignment marks may be used and those alignment marks may change state (whether color, shape, size, pattern, or the like) to guide the user into positioning his or her head properly for digital capture of a biometric representation. As one non-limiting example, the alignment marks may change shape from an X to an O as the user's head comes closer to, and ultimately into, the proper alignment.

As shown, the current alignment marks 106A may be visually differentiated from the goal alignment marks 106B, such as by shape, color, pattern, and so on. For example, the current alignment marks 106A are shown as solid shapes that fit within hollow shapes of the goal alignment marks 106B. However, it is understood that this is an example. In other implementations, other indicators may be used, which may include one or more different shapes, colors, patterns, and so on.

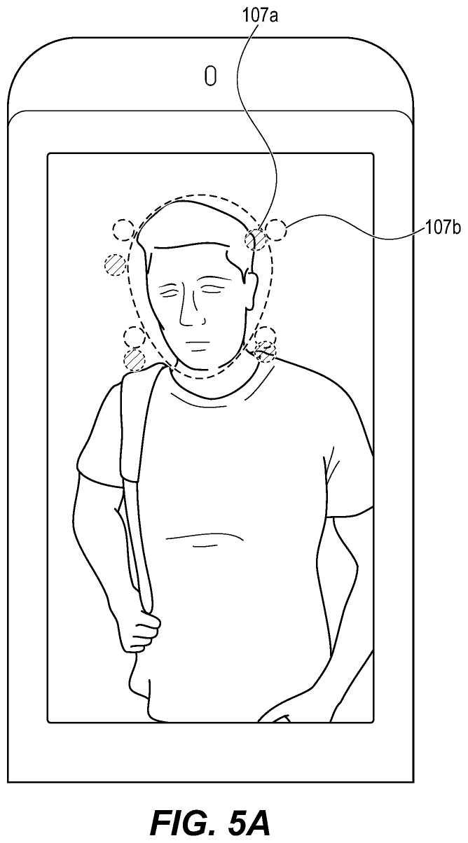

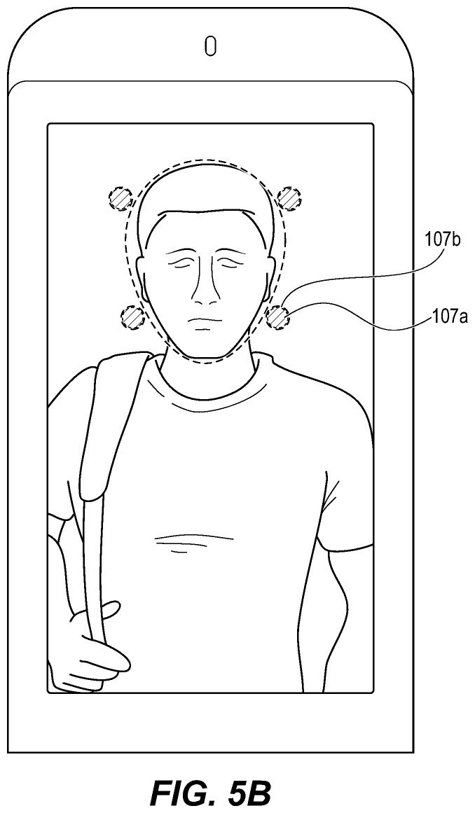

By way of illustration, FIG. 5A depicts a third example user interface. Similar to the user interface of FIGS. 4A-4B, the third example user interface may include current alignment marks 107A and goal alignment marks 107B. As shown, the current alignment marks 107A and goal alignment marks 107B are shaped differently than the current alignment marks 106A and goal alignment marks 106B of FIGS. 4A-4B, although this is not necessary. The current and goal alignment marks may be different shapes, sizes, patterns, or the like instead of, or in addition to, being different colors, or may be identical. FIG. 5B depicts the third example user interface after movement.

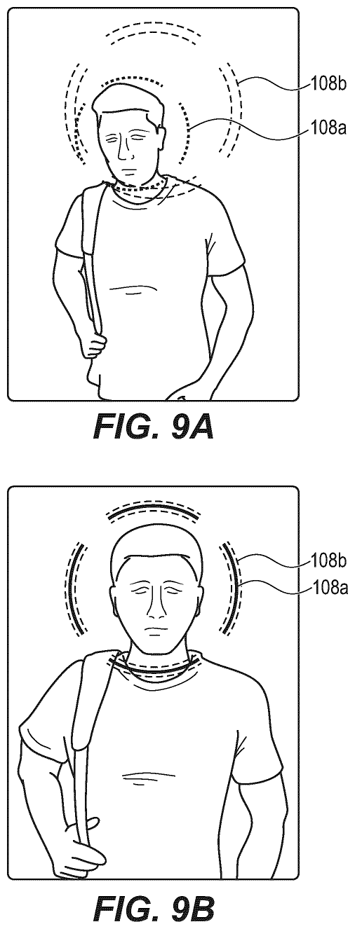

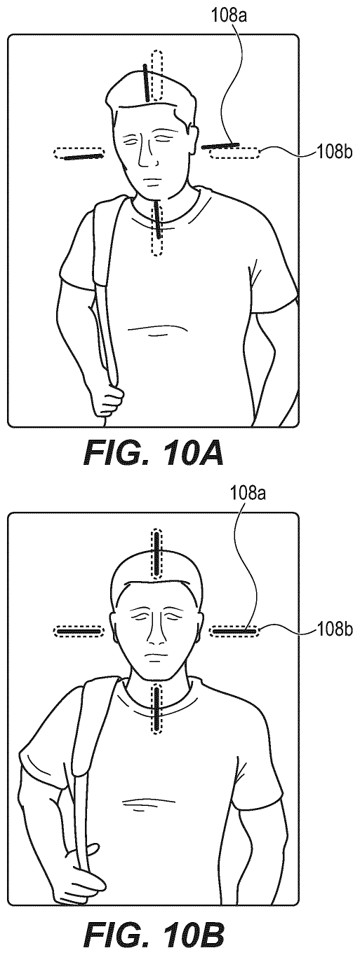

In this example, the current alignment marks 107A include at least four current alignment marks 107A and the goal alignment marks 107B include at least four current alignment marks 107B. However, it is understood that this is an example. In various implementations, different numbers of marks may be used, and the number of the current alignment marks 107A may either be the same as the number of the goal alignment marks 107B or differ. For example, FIG. 9A depicts a fourth example user interface with current alignment marks 108A and goal alignment marks 108B (with FIG. 9B depicting the fourth example user interface after movement) and FIG. 10A depicts a fifth example user interface with current alignment marks 109A and goal alignment marks 109B (with FIG. 10B depicts the fifth example user interface after movement). Various configurations are possible and contemplated without departing from the scope of the present disclosure.

FIG. 6 is a flow chart illustrating a first example method 600 for providing user interface guides for biometric enrollment and/or capture. The method 600 may be performed by devices of FIGS. 1A-1B and/or 8 and may provide user interfaces, such as the user interfaces of FIGS. 2A-2B.

At operation 610, an electronic device (such as the biometric device 101 of FIGS. 1A-1B and/or 8) may capture one or more images of a person. In some examples, the one or more images may be video.

At operation 620, the electronic device may detect a face in the one or more images. The face may be detected using image processing, or more sensors (such as described elsewhere heing), and so on.

At operation 630, the electronic device may apply a reticle to a portion of the one or more images corresponding to the face. The relationship between the edges of the reticle and the person's face may correspond to the person's relationship to a capture volume, such as the capture volume 104 of FIGS. 1A and 1B. For example, the closer a person becomes to the capture volume, the smaller the distance may become between the edges of the reticle and the person's face. Conversely, the further a person goes from the capture volume, the greater the distance may become between the edges of the reticle and the person's face. Similarly, the edges of the reticle may go beyond the person's face when the person exceeds the capture volume and the amount that the edges of the reticle go beyond the person's face may be proportional to the amount that the person has exceeded the capture volume. In this way, the person may see from the relationship between the reticle and their face whether to move forward or back, as well as how much.

At operation 640, the electronic device may display the one or more images with the reticle. The electronic device may display the one or more images with the reticle as video.

At operation 650, the electronic device may adjust the reticle in the displayed one or more images for movement of the person. For example, the electronic device may again apply a reticle to a portion of the one or more images corresponding to the face based on the new position of the person.

The flow may then return to operation 610 where the electronic device may again capture images of the person.

In some examples, a distance to the person may be determined. The distance may be determined using a sensor (such as a proximity sensor, a depth sensor, a distance sensor, an image sensor, and so on). Application of the reticle may use the distance, such as by correlating the distance to the person with a location of the capture volume. Various configurations are possible and contemplated without departing from the scope of the present disclosure.

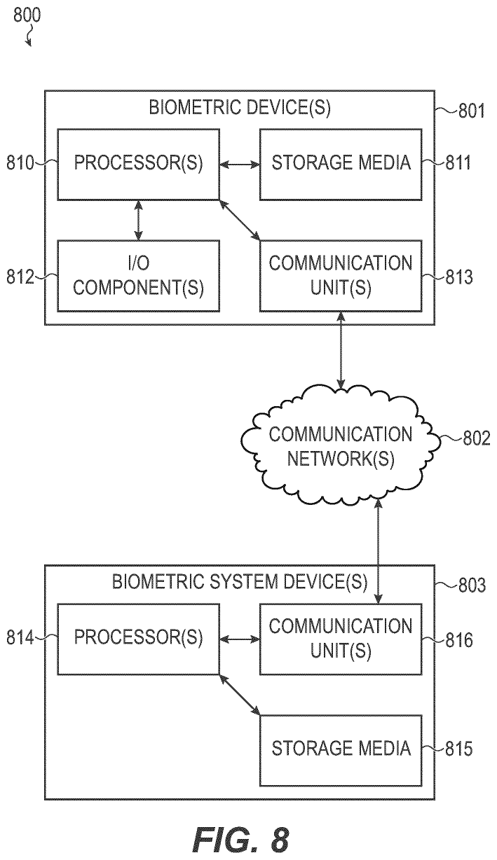

In various examples, this example method 600 may be implemented using a group of interrelated software modules or components that perform various functions discussed herein. These software modules or components may be executed within a cloud network and/or by one or more computing devices, such as the biometric device 101 of FIGS. 1A-1B and/or 8 and/or the biometric system device 803 of FIG. 8.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is shown and described as operations 60-650 being performed linearly. However, it is understood that this is an example. In various implementations, operations 610 and/05 640 may be performed continuously with operations 620, 630, and/or 650 performed interspersed therein. Various configurations are possible and contemplated without departing from the scope of the present disclosure.

FIG. 7 is a flow chart illustrating a second example method 700 for providing user interface guides for biometric enrollment and/or capture. The method may be performed by devices of FIGS. 1A-1B and/or 8 and may provide user interfaces, such as the user interfaces of FIGS. 4A-5B.

At operation 710, an electronic device (such as the biometric device 101 of FIGS. 1A-1B and/or 8) may capture one or more images of a person. In some examples, the one or more images may be video. At operation 720, the electronic device may detect a face in the one or more images. The face may be detected using image processing, or more sensors (such as one or more proximity sensors, depth sensors, distance sensors, and so on), and so on.

At operation 730, the electronic device may apply current and goal alignment marks around a portion of the one or more images corresponding to the face. The position of the current alignment marks with respect to the goal alignment marks may indicate the amount of roll/pitch/yaw. For example the closer the current alignment marks are to the goal alignment marks, the smaller the amount of roll/pitch/yaw may be. Conversely, the further the current alignment marks are from the goal alignment marks, the greater the amount of roll/pitch/yaw may be.

At operation 740, the electronic device may display the one or more images with the current and goal alignment marks. The electronic device may display the one or more images with the current and goal alignment marks as video.

At operation 750, the electronic device may adjust the current and goal alignment marks in the displayed one or more images for movement of the person. For example, the electronic device may again apply current and goal alignment marks around a portion of the one or more images corresponding to the face based on the new position of the person.

The flow may then return to operation 710 where the electronic device may again capture images of the person.

In various examples, this example method 700 may be implemented using a group of interrelated software modules or components that perform various functions discussed herein. These software modules or components may be executed within a cloud network and/or by one or more computing devices, such as the biometric device 101 of FIGS. 1A-1B and/or 8 and/or the biometric system device 803 of FIG. 8.

Although the example method 700 is illustrated and described as including particular operations performed in a particular order, it is understood that this is an example. In various implementations, various orders of the same, similar, and/or different operations may be performed without departing from the scope of the present disclosure.

For example, the above describes applying the current and goal alignment marks to one or more images of the person. However, it is understood that this is an example. In some implementations, the current and goal alignment marks may be applied to a representation of the person (such as a stick figure) that corresponds to a position of the person instead of one or more images of the person. Various configurations are possible and contemplated without departing from the scope of the present disclosure.

FIG. 8 depicts an example system 100 for providing user interface guides for biometric enrollment and/or capture. The system 100 may include one or more biometric devices 801 that communicate with one or more biometric system devices 803 via one or more communication networks. For example, the biometric device may capture one or more digital representations of biometrics (such as one or more facial images or the like), enroll one or more people in one or more biometric system, transmit the one or more biometrics to the biometric system device 803 for biometric identification, receive information regarding biometric identifications (such as identity data stored by the biometric system device 803 in association with biometric data corresponding to one or more currently obtained digital representations of biometrics, and so on.

The identity system device 803 may store identity information (such as one or more names, addresses, telephone numbers, social security numbers, patient identification numbers or other identifiers, insurance data, financial data, health information (such as one or more temperatures, pupil dilation, medical diagnoses, immunocompromised conditions, medical histories, medical records, infection statuses, vaccinations, immunology data, results of antibody tests evidencing that a person has had a particular communicable illness and recovered, blood test results, saliva test results, and/or the like), and so on) associated with the identities of people (which may be verified identities, where the identities are verified as corresponding to the particular person named and/or where the identity information is verified as valid). Alternatively and/or additionally, some or all of the health information may be stored separately from the identity information but otherwise associated with the identity information, such as in a Health Insurance Portability and Accountability Act (“HIPAA”) compliant or other data store or enclave. Such a data store or enclave may be stored one or more different storage media than the identity information or may be stored on the same storage medium or media and logically isolated from the identity information. The health information may be simultaneously and/or substantially simultaneously accessible as the identity information, such as where the identity information includes a health information identifier or key that may be used to access the separately stored health information. The identity system device 803 may control access to the identity information and/or the health information using identification information that is associated with the identity information. The identification information may include biometric data (which may include one or more digital representations of one or more fingerprints, blood vessel scans, palm-vein scans, voiceprints, facial images, retina images, iris images, deoxyribonucleic acid sequences, heart rhythms, gaits, and so on), one or more logins and/or passwords, authorization tokens, social media and/or other accounts, and so on. In various implementations, the identity system device 803 may allow the person associated with an identity to control access to the identity information, the health information, and/or other information (such as payment account information, health information (such as medical records, HIPAA protected information in order to be compliant with various legal restrictions, and so on), contact information, and so on. The identity system device 803 may control access to such information according to input received from the person. The identity system device 803 may be operable to communicate with a biometric device in order to handle requests to provide the identity information and/or the health information, update and/or otherwise add to the identity information and/or the health information, provide attestations regarding and/or related to the identity information and/or the health information (such as whether or not a person is of a particular age, whether or not a person has a particular license or insurance policy, whether or not a person has been monitored as having particular health information, whether or not a person has had a particular vaccination, whether or not an antibody test evidences that a person has had a particular communicable illness and recovered, whether or not a person has a particular ticket or authorization, whether or not a person has been monitored as having particular antibodies, whether or not a person has been assigned a particular medical diagnosis, and so on), evaluate health information stored in the identity information and/or otherwise associated with the identity information and/or other information stored in the identity information, perform transactions, allow or deny access, route one or more persons, and/or perform one or more other actions.

The identity system device 803 may be any kind of electronic device and/or cloud and/or other computing arrangement. Examples of such devices include, but are not limited to, one or more desktop computing devices, laptop computing devices, mobile computing devices, wearable devices, tablet computing devices, mobile telephones, kiosks and/or other stations, smart phones, printers, displays, vehicles, kitchen appliances, entertainment system devices, digital media players, and so on. The identity system device 803 may include one or more processors 814 and/or other processing units or controllers, communication units 816 (such as one or more network adapters and/or other devices used by a device to communicate with one or more other devices), non-transitory storage media 815, and/or other components. The processor 814 may execute one or more sets of instructions stored in the non-transitory storage media 815 to perform various functions, such as receiving and/or storing biometric data and/or other identification information, receiving and/or storing identity information and/or health information, matching one or more received digital representations of biometrics and/or other identification information to stored data, retrieving identity information and/or health information associated with stored data matching one or more received digital representations of biometrics and/or other identification information, providing retrieved identity information and/or health information, communicating via the communication network 802 using the communication unit 816, and so on. Alternatively and/or additionally, the identity system device 803 may involve one or more memory allocations configured to store at least one executable asset and one or more processor allocations configured to access the one or more memory allocations and execute the at least one executable asset to instantiate one or more processes and/or services, such as one or more gallery management services, biometric identifications services, and so on.

Similarly, the biometric device 801 may be any kind of device. The biometric device 801 may include one or more processors 810 and/or other processing units and/or controllers, one or more non-transitory storage media 811 (which may take the form of, but is not limited to, a magnetic storage medium; optical storage medium; magneto-optical storage medium; read only memory; random access memory; erasable programmable memory; flash memory; and so on), one or more communication units 812, one or more health sensors (not shown, such as a thermometer and/or other thermal sensor, a blood pressure sensor, a blood test sensor, a blood vessel scanner, a palm-vein scanner, a still image and/or video camera, a 2D and/or 3D image sensor, a saliva sensor, breath sensor, a deoxyribonucleic acid sensor, a heart rhythm monitor, a microphone, sweat sensors, and so on), one or more biometric reader devices (not shown, such as a fingerprint scanner, a blood vessel scanner, a palm-vein scanner, an optical fingerprint scanner, a phosphorescent fingerprint scanner, a still image and/or video camera, a 2D and/or 3D image sensor, a capacitive sensor, a saliva sensor, a deoxyribonucleic acid sensor, a heart rhythm monitor, a microphone, and so on), input and/or output components (such as one or more cameras and/or other image sensors, displays, audio devices, touch screens, keyboards, mice, and co on) and/or one or more other components. The processor 810 may execute one or more sets of instructions stored in the non-transitory storage media 811 to perform various functions, such as using the biometric reader to obtain one or more digital representations of one or more biometrics (such as a digital representation of a fingerprint, a blood vessel scan, a palm-vein scan, a voiceprint, a facial image, a retina image, an iris image, a deoxyribonucleic acid sequence, a heart rhythm, a gait, and so on) for a person, obtaining health information for a person using the health sensor, communicating with the identity system device 80-3 via the communication network 802 using the communication unit 812, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to user interface guides for biometric enrollment and/or capture. In various implementations, a system captures one or more images of a person, detects a face in the one or more images, applies a reticle to a portion of the one or more images corresponding to the face wherein a first relationship between an edge of the reticle and the face is proportional to second relationship between the person and a capture volume, displays the one or images with the reticle, and adjusts the display of the one or more images with the reticle for movement. In some implementations, a system captures one or more images of a person, detects a face in the one or more images, applies current alignment marks and goal alignment marks around a portion of the one or more images corresponding to the face based at least on pitch/roll/yaw of the face, displays the one or images with the current alignment marks and the goal alignment marks, and adjusts the display of the one or more images with the current alignment marks and the goal alignment marks for movement.

The present disclosure recognizes that biometric and/or other personal data is owned by the person from whom such biometric and/or other personal data is derived. This data can be used to the benefit of those people. For example, biometric data may be used to conveniently and reliably identify and/or authenticate the identity of people, access securely stored financial and/or other information associated with the biometric data, and so on. This may allow people to avoid repeatedly providing physical identification and/or other information.

The present disclosure further recognizes that the entities who collect, analyze, store, and/or otherwise use such biometric and/or other personal data should comply with well-established privacy policies and/or privacy practices. Particularly, such entities should implement and consistently use privacy policies and practices that are generally recognized as meeting or exceeding industry or governmental requirements for maintaining security and privately maintaining biometric and/or other personal data, including the use of encryption and security methods that meets or exceeds industry or government standards. For example, biometric and/or other personal data should be collected for legitimate and reasonable uses and not shared or sold outside of those legitimate uses. Further, such collection should occur only after receiving the informed consent. Additionally, such entities should take any needed steps for safeguarding and securing access to such biometric and/or other personal data and ensuring that others with access to the biometric and/or other personal data adhere to the same privacy policies and practices. Further, such entities should certify their adherence to widely accepted privacy policies and practices by subjecting themselves to appropriate third party evaluation.

Additionally, the present disclosure recognizes that people may block the use of, storage of, and/or access to biometric and/or other personal data. Entities who typically collect, analyze, store, and/or otherwise use such biometric and/or other personal data should implement and consistently prevent any collection, analysis, storage, and/or other use of any biometric and/or other personal data blocked by the person from whom such biometric and/or other personal data is derived.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system, comprising:
at least one non-transitory storage medium that stores instructions; and
at least one processor that executes the instructions to:
capture one or more images of a person;
detect a face in the one or more images;
apply a reticle to a portion of the one or more images corresponding to the face wherein a first relationship between an edge of the reticle and the face is proportional to second relationship between the person and a capture volume;
display the one or images with the reticle; and
adjust the display of the one or more images with the reticle for movement of the person.

2. The system of claim 1, wherein the at least one processor uses image processing to detect the face.

3. The system of claim 1, wherein a distance between the edge of the reticle and the face decreases as the person approaches the capture volume.

4. The system of claim 1, wherein the edge of the reticle goes beyond the face when the person goes beyond the capture volume.

5. The system of claim 1, wherein the at least one processor further executes the instructions to modify the at least one image to highlight an area within the reticle.

6. The system of claim 5, wherein the at least one processor highlights the area by blurring or shadowing an additional area that is outside the reticle.

7. The system of claim 1, wherein the reticle comprises an oval.

8. The system of claim 1, wherein the at least one processor further executes the instructions determine a distance to the person 9. The system of claim 8, wherein the at least one processor determines the distance using a proximity sensor, a depth sensor, or a distance sensor.

10. The system of claim 8, wherein the at least one processor applies the reticle using the distance.

11. A system, comprising:
at least one non-transitory storage medium that stores instructions; and
at least one processor that executes the instructions to:
capture one or more images of a person;
detect a face in the one or more images;
apply current alignment marks and goal alignment marks around a portion of the one or more images corresponding to the face based at least on pitch/roll/yaw of the face;
display the one or images with the current alignment marks and the goal alignment marks; and
adjust the display of the one or more images with the current alignment marks and the goal alignment marks for movement of the person.

12. The system of claim 11, wherein the current alignment marks are solid and the goal alignment marks are hollow.

13. The system of claim 11, wherein the current alignment marks fit with the goal alignment marks.

14. The system of claim 11, wherein the current alignment marks are a different color than the goal alignment marks.

15. The system of claim 11, wherein the current alignment marks are indicated with a different pattern than the goal alignment marks.

16. The system of claim 11, wherein the current alignment marks and the goal alignment marks are similarly shaped but are of different sizes.

17. The system of claim 11, wherein a proximity of the current alignment marks to the goal alignment marks indicates an amount of the pitch/roll/yaw of the face.

18. The system of claim 11, wherein the proximity increases as the amount decreases.

19. The system of claim 11, wherein the current alignment marks include at least four current alignment marks.

20. The system of claim 11, wherein a first number of the current alignment marks equals a second number of the goal alignment marks.
